(19) United States
(12) Patent Application Publication
(10) Pub. No.: US 2014/0053621 A1
(43) Pub. Date: Feb. 27, 2014

(54) HYBRID LOCK CYLINDER

(71) Applicant: Ingersoll-Rand Company, Davidson, NC (US)

(72) Inventors: Robert D. Zuraski, Taunton, MA (US); Mary Teresa Sarich, Boston, MA (US); Daniel Hugh Kindstrand, Plainville, MA (US); David Bruce Miller, Braintree, MA (US)

(21) Appl. No.: 13/963,968

(22) Filed: Aug. 9, 2013

Related U.S. Application Data
(60) Provisional application No. 61/681,541, filed on Aug. 9, 2012.

(51) Int. Cl. E05B 29/00

(52) U.S. Cl. CPC E05B 29/0033; E05B 29/0066
USPC 70/492

(57) ABSTRACT

A disclosed lock assembly is provided with one or more wafers contained in one or more wafer housings.

### BACKGROUND

The disclosed embodiments generally pertain to locks, and particularly to lock cylinder mechanisms using wafers and wafer housings.

### SUMMARY

An embodiment of the present invention increases the security of a disc-style lock by using one of the rotating discs to house coded sliding components. This lock is very difficult to pick because the thief has to defeat both systems that each require different picking techniques.

Another embodiment also provides the advantage of holding onto the key until the key has returned to its starting position. This ensures the opening in discs are realigned before the key is removed.

An additional anti-pick feature is included on the wafers. One of the wafers in each product would have an anti-pick notch that would catch on the edge of the housing during pick attempts.

### BRIEF DESCRIPTION OF THE ILLUSTRATIONS

Embodiments of the invention are illustrated in the following illustrations.

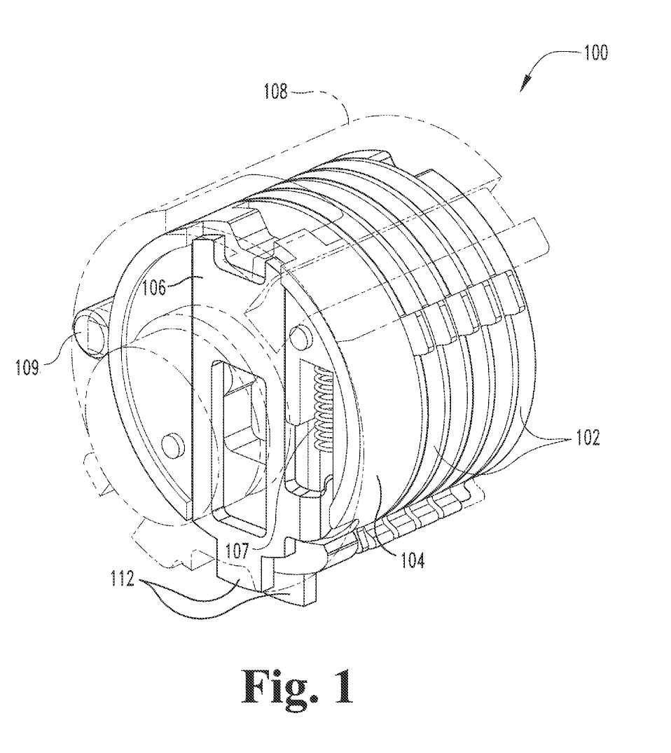

FIG. 1 illustrates a lock assembly in a first configuration with no key inserted.

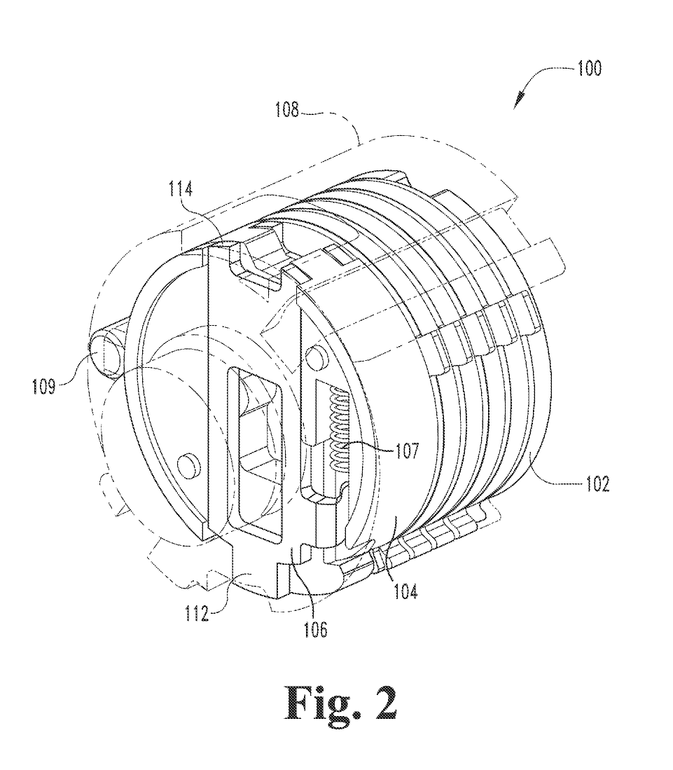

FIG. 2 shows the lock assembly of FIG. 1 in a second configuration with a correct key inserted but not yet turned.

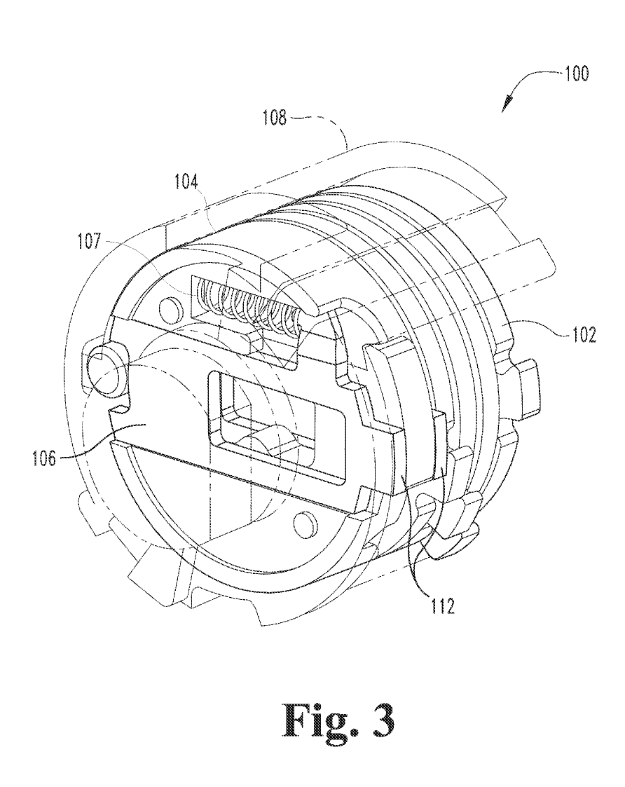

FIG. 3 depicts the lock assembly of FIG. 1 in a third configuration in which a correct key has been inserted and turned the lock assembly.

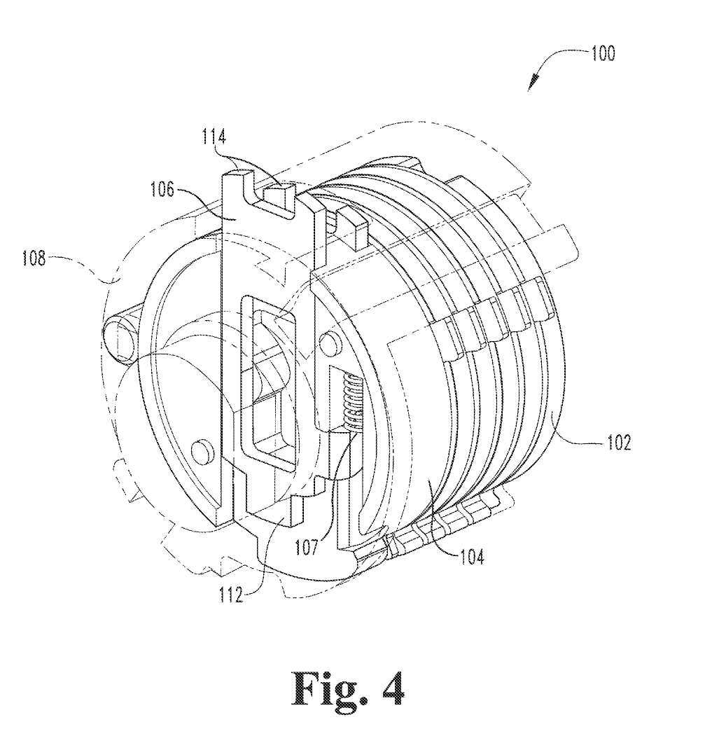

FIG. 4 illustrates the lock assembly of FIG. 1 in which an incorrect key has been inserted or an attempt to pick is being made.

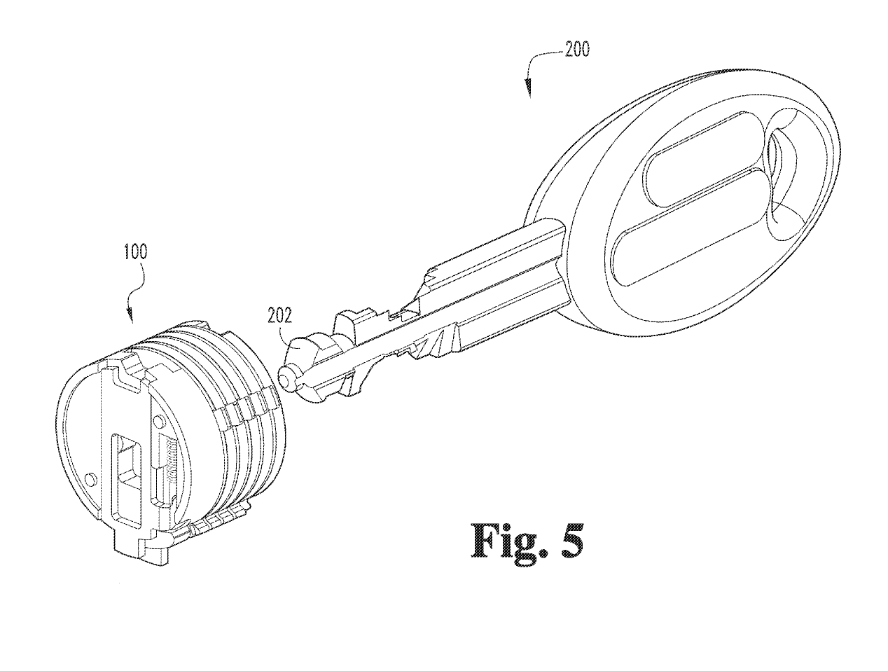

FIG. 5 shows a lock assembly and a typical key for the lock assembly.

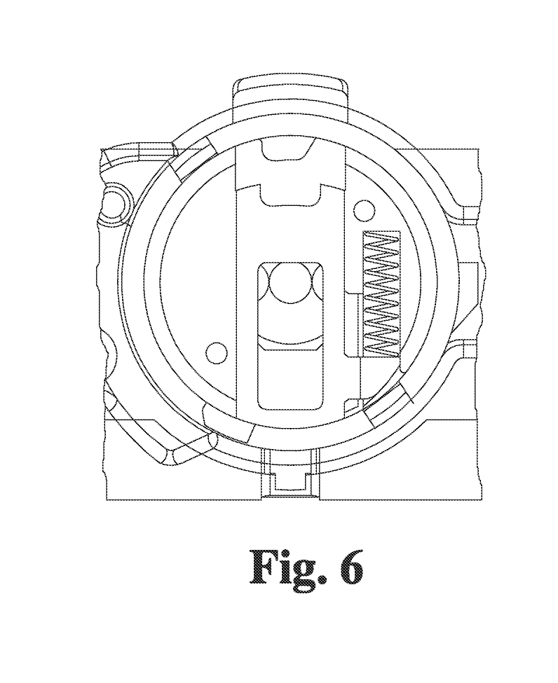

FIG. 6 depicts an additional anti-pick feature in which a wafer has a first extension member and another narrower extension member extending therefrom.

### DETAILED DESCRIPTION

Referring now to FIGS. 1-5, a lock assembly 100 is provided with a plurality of discs 102, one or more wafer housings 104 housing one or more wafers 106, a spindle 108, a locking bar 109, and a lock assembly housing 110 (not shown, see FIG. 6). Each wafer housing 104 is provided with one or more wafers 106 that are spring 107 biased in a first direction. The wafers 106 are further provided with one or more first extension members 112 at a first wafer end, and one or more second extension members 114 at a second wafer end.

Referring to FIG. 1, no key is in the lock assembly 100 and the wafers 106 are spring 107 biased such that the first extension members 112 extend through the spindle 108 and into a housing 110 (not shown, see FIG. 6). In such a configuration, the lock assembly 100 is locked by both the wafers 106 and the locking bar 109.

Referring to FIG. 2, a key 200 (not shown, see FIG. 5) is inserted in the lock assembly 100. The key 200 is provided with a ramped surface 202 (see FIG. 5) that pushes against the spring bias of the wafer 106 such that the first extension members 112 are pulled from the spindle 108 and the lock assembly housing 110, and is pulled within the wafer housing 104. This allows the wafer extension members 112 to align with the lock shear line and allows the wafer housing 104 to rotate much like the other discs 102. However with the key 200 merely inserted, the lock assembly 100 is still locked by the locking bar 109.

Referring now to FIG. 3, the lock assembly 100 is shown in a configuration in which a correct key has been inserted and unlocked the lock assembly. Recesses in the discs 102, wafer housing 104, and wafers 106 line up and the locking bar 109 can drop into the wafer recesses and release the spindle 108.

Referring now to FIG. 4, should an incorrect key be inserted that would otherwise allow the first wafer extension members 112 to clear the shear line of the lock assembly 100, second wafer extension members 114 then extend out of the wafer housing 104 and into the spindle 108 and/or the lock assembly housing 110. Thus, preventing the wafer housing 108 from rotating.

Referring now to FIG. 6, one wafer 106 in a lock assembly 100 may have a first extension member 112 provided with another narrower extension member 113 extending therefrom. This gives a lock picker a false sense that the wafer has cleared the shear line, when it in fact has not.

The lock assembly 100 may incorporate multiple independent sliding components inside of a disc. Various sizes of wafers can be used to increase the number of key codes available. The wafer housing turns as soon as the key turns and accepts the locking bar similar to a traditional disc.

The foregoing written description of structures and methods has been presented for purposes of illustration. Examples are used to disclose the invention, including the best mode, and also to enable any person skilled in the art to practice the invention, including making and using any devices or systems and performing any incorporated methods. These examples are not intended to be exhaustive or to limit the invention to the precise steps and/or forms disclosed, and many modifications and variations are possible in light of the above teaching. Features described herein may be combined in any combination. Steps of a method described herein may be performed in any sequence that is physically possible. The patentable scope of the invention is defined by the appended claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A lock assembly comprising:
one or more wafer housings;
one or more wafers contained within said one or more wafer housings;
wherein said one or more wafers are biased to interfere with a shear line of said lock assembly;
wherein insertion of a correct key into said lock assembly clears said one or more wafers of said shear line.
